(19) United States
(12) Patent Application Publication
(10) Pub. No.: US 2025/0273833 A1
(43) Pub. Date: Aug. 28, 2025

(54) SOLID-STATE BATTERY AND METHOD FOR PRODUCING THEREOF, AND BATTERY MODULE

(71) Applicant: TOYOTA JIDOSHA KABUSHIKI KAISHA, Toyota-shi (JP)

(72) Inventors: Kenichi KAKISHITA, Nagoya-shi (JP); Masashi Chihara, Nagoya-shi (JP)

(73) Assignee: TOYOTA JIDOSHA KABUSHIKI KAISHA, Toyota-shi (JP)

(21) Appl. No.: 19/034,952

(22) Filed: Jan. 23, 2025

(30) Foreign Application Priority Data
Feb. 28, 2024 (JP) 2024-028898

(51) Int. Cl. H01M 50/586; H01M 10/04; H01M 10/0562; H01M 10/0565; H01M 50/105

(52) U.S. Cl. CPC H01M 50/586; H01M 10/0468; H01M 10/0562; H01M 10/0565; H01M 50/105

(57) ABSTRACT

The present disclosure provides a solid-state battery with highly reliable insulation by an insulating member. The solid-state battery 10 of the disclosure comprises an electrode stack 110.The electrode stack has a first current collector layer 111, a first electrode active material layer 112, a solid electrolyte layer 113, a second electrode active material layer 114 and a second current collector layer 115, in that order. An insulating member 120 is disposed on at least part of the edge of the electrode stack. The second current collector layer extends from the edge of the electrode stack on which the insulating member is disposed, and the insulating member is joined with the electrode stack and second current collector layer. The insulating member extends from the edge of the electrode stack along the second current collector layer.

### FIELD

The present disclosure relates to a solid-state battery and a method for producing thereof, and to a battery module.

### BACKGROUND

Electric vehicles and hybrid vehicles are being developed with an increasing level of environmental awareness in the automobile industry, leading to demands for higher voltage secondary batteries. With the ongoing popularity and development of portable electronic devices as well, smaller and more lightweight high-capacity secondary batteries are needed that are able to continuously operate for longer periods of time.

As high-voltage and high-capacity batteries, batteries are known that comprise an electrode stack having a negative electrode collector layer, a negative electrode active material layer, a solid electrolyte layer, a positive electrode active material layer and a positive electrode collector layer, in that order.

With such a battery, if the current collector layer of one electrode extends from the electrode stack, for example, then it may contact with the current collector layer and/or active material layer of the other electrode, resulting in short circuiting. The part of a current collector layer extending from an electrode stack is referred to as a “collector tab”. Such short circuiting is particularly notable when the area of the current collector layer of one electrode is larger than the area of the current collector layer of the other electrode. Techniques have therefore been developed to prevent such short circuiting.

PTL 1, for example, discloses a method for producing a stacked all-solid-state battery, wherein the method comprises: preparing a first stack comprising a solid electrolyte layer, a first active material layer (electrode active material layer), a first current collector layer with a first collector tab extending to the side of the stacked all-solid-state battery, a first active material layer, and a solid electrolyte layer stacked in that order, coating the edge of the first stack with an insulator coating solution to form an insulation section (insulating member), stacking the first stack on which the insulation section is formed, a second active material layer, and a second current collector layer with a second collector tab extending to the side of the stacked all-solid-state battery, to prepare a battery structure (electrode stack) having a plurality of second laminated bodies each comprising a second current collector layer with a second collector tab, a second active material layer, a solid electrolyte layer, a first active material layer, a first current collector layer with a first collector tab, a first active material layer, a solid electrolyte layer, and a second active material layer, in that order, and joining a plurality of second collector tabs respectively extending from the plurality of second current collectors of the battery structure.

### CITATION LIST

### Patent Literature

[PTL 1] Japanese Unexamined Patent Publication No. 2018-049696

### SUMMARY

### Technical Problem

The present inventors have found that when an insulating member is applied at the edge of a preliminary stack constructed from a layer of the electrode stack other than the second current collector layer, and the second current collector layer is layered onto the preliminary stack to produce an electrode stack, the second current collector layer and insulating member interfere, resulting in peeling of the insulating member from the electrode stack, and often lowering the insulating reliability of the insulating member.

It is an object of the present disclosure to provide a solid-state battery with highly reliable insulation by an insulating member and a method for producing thereof, and a battery module comprising the solid-state battery.

### Solution to Problem

The present inventors have found that the aforementioned object can be achieved by the following means.

### Aspect 1

A solid-state battery comprising an electrode stack, wherein:
the electrode stack has a first current collector layer, a first electrode active material layer, a solid electrolyte layer, a second electrode active material layer and a second current collector layer, in that order,
an insulating member is disposed on at least part of the edge of the electrode stack,
the second current collector layer extends from the edge of the electrode stack on which the insulating member is disposed,
the insulating member is joined with the electrode stack and the second current collector layer, and
the insulating member extends from the edge of the electrode stack along the second current collector layer.

### Aspect 2

The solid-state battery according to aspect 1, wherein:
the electrode stack has the first electrode active material layer, the solid electrolyte layer, the second electrode active material layer and the second current collector layer in that order on both sides of the first current collector layer, and
the insulating member is joined with the electrode stack and the two second current collector layers.

### Aspect 3

The solid-state battery according to aspect 1 or 2, wherein the insulating member has a shape that is recessed toward the electrode stack.

### Aspect 4

The solid-state battery according to any one of aspects 1 to 3, wherein the first current collector layer is a negative electrode collector layer, the first electrode active material layer is a negative electrode active material layer, the second electrode active material layer is a positive electrode active material layer and the second current collector layer is a positive electrode collector layer.

### Aspect 5

A battery module comprising a solid-state battery according to aspect 4.

### Aspect 6

A method for producing a solid-state battery according to any one of aspects 1 to 3, the method comprising the following steps:
(a) stacking the first current collector layer, the first electrode active material layer, the solid electrolyte layer and the second electrode active material layer in that order to form a preliminary stack,
(b) applying the insulating member onto part of the second current collector layer,
(c) stacking the second current collector layer on the main side of the preliminary stack in such a manner that the edge of the preliminary stack and the insulating member match in the in-plane direction of the preliminary stack,
(d) pressing the second current collector layer to cause flow of the insulating member at the edge of the preliminary stack, to form an electrode stack with the insulating member disposed on at least part of the edge, and
(e) solidifying the insulating member.

### Aspect 7

The method according to aspect 6, wherein:
the insulating member includes a thermoplastic resin,
in step (d), the method further comprises melting the thermoplastic resin and the insulating member including the molten thermoplastic resin is caused to flow on the edge of the preliminary stack, and
in step (e), the insulating member containing the molten thermoplastic resin is solidified.

### Aspect 8

The method according to aspect 6, wherein:
the insulating member is a curable resin, and
in step (e), the insulating member containing the curable resin is solidified by curing.

### Aspect 9

A method for producing a solid-state battery according to any one of aspects 1 to 3, the method comprising the following steps:
(a) stacking the first electrode active material layer, the solid electrolyte layer and the second electrode active material layer in that order on both sides of the first current collector layer to form a preliminary stack,
(b) stacking the first second current collector layer on one main side of the preliminary stack,
(c) applying the insulating member onto the edge of the preliminary stack and at least part of the section of the first second current collector layer that extends from the preliminary stack,
(d) stacking the second second current collector layer on the other main side of the preliminary stack,
(e) pressing the second second current collector layer to form the electrode stack having the insulating member disposed at the edge, and
(f) solidifying the insulating member.

### Aspect 10

The method according to aspect 9, wherein:
the insulating member includes a thermoplastic resin,
in step (c), the method further comprises melting the insulating member including the thermoplastic resin and
in step (f), the insulating member containing the molten thermoplastic resin is solidified.

### Aspect 11

The method according to aspect 9, wherein:
the insulating member includes a curable resin, and in step (f), the insulating member containing the curable resin is solidified by curing.

### ADVANTAGEOUS EFFECTS OF INVENTION

According to the present disclosure it is possible to provide a solid-state battery with highly reliable insulation by an insulating member and a method for producing thereof, and a battery module comprising the solid-state battery.

### BRIEF DESCRIPTION OF DRAWINGS

FIG. 1 is a schematic plan view showing an example of a solid-state battery of the disclosure.

FIG. 2 is a simplified cross-sectional view showing an example of a method of disposing an insulating member in a solid-state battery of the disclosure.

FIG. 3 is a simplified cross-sectional view showing an example of a method of disposing an insulating member in a solid-state battery of the disclosure.

FIG. 4A is a schematic diagram illustrating the method of the disclosure for producing a solid-state battery.

FIG. 4B is a schematic diagram illustrating the method of the disclosure for producing a solid-state battery.

FIG. 4C is a schematic diagram illustrating the method of the disclosure for producing a solid-state battery.

FIG. 5 is a schematic diagram illustrating the positional relationship between a preliminary stack and an insulating member in the method of the disclosure for producing a solid-state battery.

FIG. 6A is a schematic diagram illustrating the method of the disclosure for producing a solid-state battery.

FIG. 6B is a schematic diagram illustrating the method of the disclosure for producing a solid-state battery.

FIG. 6C is a schematic diagram illustrating the method of the disclosure for producing a solid-state battery.

FIG. 6D is a schematic diagram illustrating the method of the disclosure for producing a solid-state battery.

FIG. 6E is a schematic diagram illustrating the method of the disclosure for producing a solid-state battery.

FIG. 7 is a simplified perspective view showing an example of a battery module of the disclosure.

### DESCRIPTION OF EMBODIMENTS

An embodiment of the disclosure will now be described in detail with reference to the accompanying drawings. The disclosure is not limited to the embodiment described below, however, and various modifications may be implemented which do not depart from the gist thereof. The dimensional relationships in the drawings do not reflect actual dimensional relationships.

### Solid-State Battery

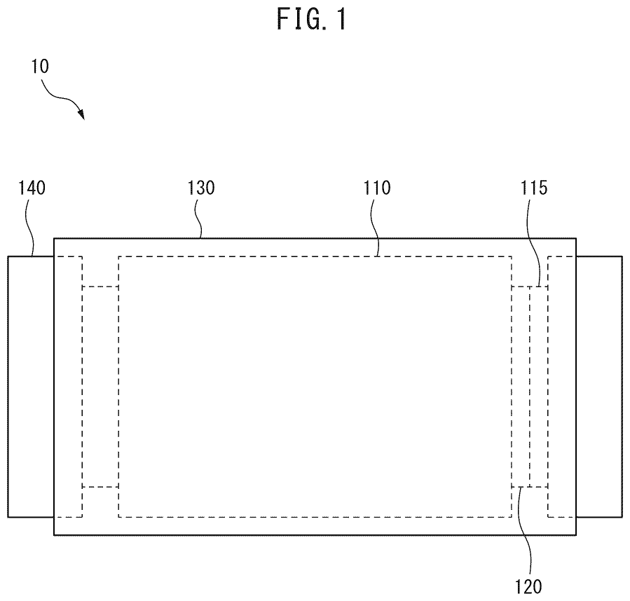

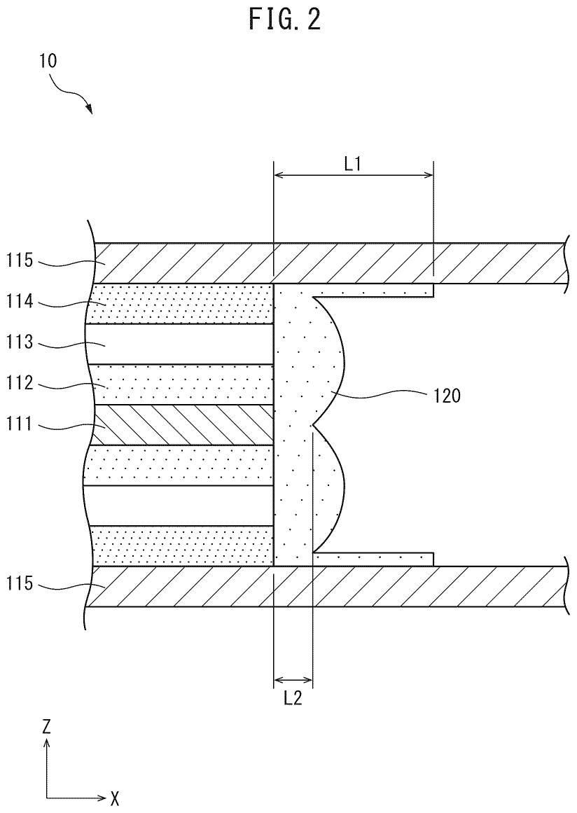

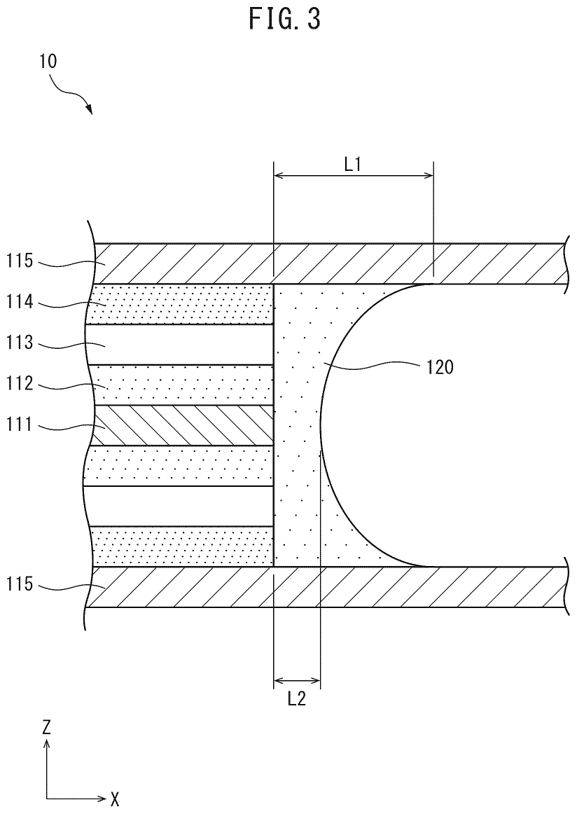

As exemplified in FIG. 1, the solid-state battery 10 of the disclosure comprises an electrode stack 110. As exemplified in FIGS. 2 and 3, the electrode stack has a first current collector layer 111, a first electrode active material layer 112, a solid electrolyte layer 113, a second electrode active material layer 114 and a second current collector layer 115, in that order. An insulating member 120 is disposed on at least part of the edge of the electrode stack. The second current collector layer extends from the edge of the electrode stack on which the insulating member is disposed, and the insulating member is joined with the electrode stack and second current collector layer. The insulating member extends from the edge of the electrode stack along the second current collector layer. FIGS. 2 and 3 are magnified simple cross-sectional views of part of the insulating member 120 of the solid-state battery 10 of the disclosure.

The present inventors have found that with a construction in which the insulating member is joined to the electrode stack and second current collector layer and the insulating member extends from the edge of the electrode stack along the second current collector layer, the reliability of insulation by the insulating member is higher. The reason for this is believed to be that the insulating member is joined to the electrode stack and second current collector layer helping, to prevent shedding of the insulating member from the electrode stack.

It is also thought that having the insulating member extend from the edge of the electrode stack along the second current collector layer allows the insulating member to reinforce the second current collector layer to help prevent tearing.

As exemplified in FIGS. 2 and 3, the electrode stack may have the first electrode active material layer, solid electrolyte layer, second electrode active material layer and second current collector layer in that order on both sides of the first current collector layer, and the insulating member may be joined to the electrode stack and the two second current collector layers. Such a construction can more effectively inhibit shedding of the insulating member from the electrode stack, thus allowing higher reliability of insulation by the insulating member.

The term “solid-state battery” as used herein refers to a battery using at least a solid electrolyte as the electrolyte, and the solid-state battery may also employ a combination of a solid electrolyte and a liquid electrolyte as the electrolyte. The solid-state battery of the disclosure may also be an all-solid-state battery, i.e. a battery employing only a solid electrolyte as the electrolyte.

The solid-state battery of the disclosure may be a lithium ion secondary battery. Examples of battery uses include power sources for vehicles such as hybrid vehicles (HEV), plug-in hybrid vehicles (PHEV), electric vehicles (BEV), gasoline automobiles and diesel automobiles. The battery is most preferably used as a drive power supply unit for a hybrid vehicle (HEV), plug-in hybrid vehicle (PHEV) or electric vehicle (BEV). The battery of the disclosure may also be used as a power source for a traveling body other than a vehicle (such as a railway car, ship or aircraft), or as a power source for an electrical product such as an information processing device.

The elements composing the solid-state battery of the disclosure will now be described.

### Electrode Stack

The solid-state battery 10 of the disclosure comprises an electrode stack 110. The electrode stack functions as a power generating element in the battery. As exemplified in FIGS. 2 and 3, the electrode stack may have a first electrode active material layer, a solid electrolyte layer, a second electrode active material layer and a second current collector layer in that order, on both sides of the first current collector layer. In other words, the electrode stack may have a second current collector layer, a second electrode active material layer, a solid electrolyte layer, a first electrode active material layer, a first current collector layer, a first electrode active material layer, a solid electrolyte layer, a second electrode active material layer and a second current collector layer, in that order.

The first current collector layer may be a negative electrode collector layer, the first electrode active material layer may be a negative electrode active material layer, the second electrode active material layer may be a positive electrode active material layer and the second current collector layer may be a positive electrode collector layer. In other words, the electrode stack may have a negative electrode collector layer, negative electrode active material layer, solid electrolyte layer, positive electrode active material layer and positive electrode collector layer, in that order.

The shape of the electrode stack is not particularly restricted, and for example, it may have a top side section, a bottom side section facing the top side section, and four side sections connecting the top side section and bottom side section. The shape of the top side section is also not particularly restricted, and for example, it may be quadrilateral, such as square, rectangular, rhomboid, trapezoid or parallelogram-shaped. The shape of the top side section may also be a polygonal shape other than quadrilateral, or it may be a shape having curves, such as circular. The shape of the bottom side section may be the same shape as the top side section. The shapes of the side sections are also not particularly restricted, and for example, they may be quadrilateral, such as square, rectangular, rhomboid, trapezoid or parallelogram-shaped.

The size of the electrode stack is not particularly restricted and may be appropriately designed according to the properties desired for the battery, for example.

The constituent members of the electrode stack of the disclosure will now be described.

For convenience in explanation, each member will be described in terms of an electrode stack for a solid lithium ion secondary battery, but the solid-state battery of the disclosure is not limited to a lithium ion secondary battery.

### Positive Electrode Collector Layer

The conductive material used in the positive electrode collector layer is not particularly restricted and may be SUS, aluminum, copper, nickel, iron, titanium or carbon, for example.

The form of the positive electrode collector layer is not particularly restricted and may be, for example, a foil, sheet, mesh, porous body or the like. A foil is preferred among these.

The positive electrode collector layer may extend from the edge of the electrode stack, with a plurality of positive electrode collector layers joined at the extending part.

### Positive Electrode Active Material Layer

The positive electrode active material layer also includes at least a positive electrode active material, and it preferably further includes the solid electrolyte described below. In addition, it may include additives used in positive electrode active material layers for solid-state batteries, such as conductive aids and binders, for example, depending on the application and the purpose of use.

The material of the positive electrode active material is not particularly restricted. Examples for the positive electrode active material include heterogenous element-substituted Li—Mn spinel having a composition represented as lithium cobaltate (LiCoO₂), lithium nickelate (LiNiO₂), lithium manganate (LiMn₂O₄), Li_{1.5}Co_{1/3}Ni_{1/3}Mn_{1/3}O₂, LiCo_{1/3}Ni_{1/3}Mn_{1/3}O₂ or Li₁₊ₓMn_{2-x-y}M_{y}O₄ (where M is one or more metal elements selected from among Al, Mg, Co, Fe, Ni and Zn).

The conductive aid is not particularly restricted. For example, the conductive aid may be a carbon material such as VGCF (Vapor Grown Carbon Fibers) or carbon nanofibers, or a metal material.

The binder is also not particularly restricted. For example, the binder may be a material such as polyvinylidene fluoride (PVdF), carboxymethyl cellulose (CMC), butadiene rubber (BR) or styrene-butadiene rubber (SBR), or a combination thereof.

### Solid Electrolyte Layer

The solid electrolyte layer includes at least a solid electrolyte. The solid electrolyte used is not particularly restricted, and it may be any material that can be used as a solid electrolyte for a solid-state battery. For example, the solid electrolyte may be a sulfide solid electrolyte, an oxide solid electrolyte or a polymer electrolyte, although this is not limitative.

Examples of sulfide solid electrolytes include, but are not limited to, sulfide-based amorphous solid electrolytes, sulfide-based crystalline solid electrolytes and argyrodite solid electrolytes. Specific examples of sulfide solid electrolytes include, but are not limited to, Li₂S—P₂S₅ (Li₇P₃S₁₁, Li₃PS₄, Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂), LiI—Li₂S—P₂O₅, LiI—Li₃PO₄—P₂S₅ and Li₇₋ₓPS₆₋ₓClₓ, as well as combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄ and Li₃₊ₓPO₄₋ₓNₓ(LiPON).

Polymer electrolytes include, but are not limited to, polyethylene oxide (PEO) and polypropylene oxide (PPO), and their copolymers.

The solid electrolyte may be glass or crystallized glass (glass ceramic). The solid electrolyte layer may include a conductive aid or a binder, for example, as necessary, in addition to the solid electrolyte mentioned above. The conductive aid and binder may be understood by referring to the aforementioned description regarding the positive electrode active material layer.

### Negative Electrode Active Material Layer

The negative electrode active material layer includes at least a negative electrode active material, and it preferably further includes the solid electrolyte described above. In addition, it may include additives used in negative electrode active material layers for solid-state batteries, such as conductive aids and binders, for example, depending on the application and the purpose of use.

The material for the negative electrode active material is not particularly restricted, but it is preferably one that is capable of occluding and releasing metal ions such as lithium ions. For example, the negative electrode active material may be, but is not limited to, an oxide-based negative electrode active material, alloy-based negative electrode active material or carbon material.

Oxide-based negative electrode active materials are not particularly restricted and include lithium titanate (LTO) particles.

Alloy-based negative electrode active materials are not particularly restricted, and examples include Si alloy-based negative electrode active materials and Sn alloy-based negative electrode active materials. Examples of Si alloy-based negative electrode active materials include silicon, silicon oxides, silicon carbides, silicon nitrides, and their solid solutions. A Si alloy-based negative electrode active material may also include elements other than silicon, such as Fe, Co, Sb, Bi, Pb, Ni, Cu, Zn, Ge, In, Sn and Ti, for example. Examples of Sn alloy-based negative electrode active materials include tin, tin oxides, tin nitrides, and their solid solutions. A Sn alloy-based negative electrode active material may also include elements other than tin, such as Fe, Co, Sb, Bi, Pb, Ni, Cu, Zn, Ge, In, Ti and Si, for example.

Carbon materials are not particularly restricted and include hard carbon, soft carbon and graphite, for example.

The solid electrolyte to be used in the negative electrode active material layer will be understood by referring to the aforementioned description of the solid electrolyte layer, while the conductive aid and binder will be understood by referring to the aforementioned description of the positive electrode active material layer.

### Negative Electrode Collector Layer

The conductive material used in the negative electrode collector layer is not particularly restricted and may be, but is not limited to, SUS, aluminum, copper, nickel, iron, titanium or carbon, for example.

The form of the negative electrode collector layer is not particularly restricted and may be, for example, a foil, sheet, mesh, porous body or the like. A foil is preferred among these.

The negative electrode collector layer may extend from the edge of the electrode stack, with a plurality of negative electrode collector layers joined at the extending part.

### Insulating Member

As exemplified in FIGS. 2 and 3, the insulating member 120 may have a shape which is recessed toward the electrode stack 110. With such a construction it is possible to increase the follow property of the insulating member along curvature of the second current collector layer, compared to when the insulating member has a shape which is not recessed toward the electrode stack, thus resulting in higher reliability of insulation by the insulating member. It will also be possible to reduce the amount of material used for the insulating member.

When the insulating member has a shape that is recessed toward the electrode stack, the length Ll of the section of the insulating member in contact with the second current collector layer may be 100 μm or greater, 300 μm or greater, 500 μm or greater or 1 mm or greater, and 3 mm or less, 2 mm or less, 1 mm or less or 500 μm or less. Such a construction can suitably reinforce the second current collector layer. It also allows the insulating member to be disposed without overly impairing volumetric efficiency in the in-plane direction of the electrode stack, i.e. the x-direction in FIGS. 2 and 3.

When the insulating member has a shape that is recessed toward the electrode stack, the length L2 from the edge of the electrode stack to the top of the recess may be 10 μm or greater, 20 μm or greater, 30 μm or greater, 50 μm or 100 μm or greater, and 500 82 m or less, 300 μm or less or 100 μm or less. Such a construction can ensure insulation by the insulating member and reduce the amount of material used for the insulating member. In FIG. 2, the recesses include the recess formed near the center in the stacking direction of the electrode stack and the two recesses formed along the second current collector layers. FIG. 2 shows a case where the length L2 is equal for each of the recesses, but the length L2 may also differ for each of the recesses.

The insulating member 120 may include a thermoplastic resin, or it may be a thermoplastic resin. The thermoplastic resin is not particularly restricted and may be either a non-reactive type or reactive type. A non-reactive type thermoplastic resin is not particularly restricted, and examples include ethylene-vinyl acetate (EVA)-based, synthetic rubber, olefin-based, polyamide-based and polyester-based (such as polyethylene terephthalate (PET)) resins. A reactive type resin is also not particularly restricted, and examples include urethane-based resins.

The insulating member 120 may include a curable resin, or it may be a curable resin. A curable resin is not particularly restricted, and examples include thermosetting resins and photocuring resins. Such resins may be acrylic or epoxy resins, for example.

The shape of the insulating member 120 is not particularly restricted, but as mentioned above it is most preferably a shape that is recessed toward the electrode stack 110.

The size of the insulating member 120 is also not particularly restricted, and it may be designed as appropriate in consideration of volumetric efficiency of the battery.

### Laminate Film

The solid-state battery 10 of the disclosure may have a laminate film 130. The laminate film may house the electrode stack. Specifically, the laminate film may house the electrode stack by winding around the electrode stack. Alternatively, the laminate film may be constructed of first and second films, in which case it may sandwich and house the electrode stack with the first and second films from above and below in the stacking direction of the electrode stack.

The laminate film may have a sealant resin layer, a metal layer and a protective resin layer, in that order along the thickness direction. Examples of materials for the sealant resin layer include olefin-based resins such as polypropylene (PP) and polyethylene (PE). Examples of materials for the metal layer include aluminum, aluminum alloy and stainless steel. Examples of materials for the protective resin layer include polyethylene terephthalate (PET) and nylon.

The thicknesses of the layers forming the laminate film and of the laminate film itself are not particularly restricted. The thickness of the sealant resin layer may be 40 μm to 100 μm, for example. The thickness of the metal layer may be 30 μm to 60 μm, for example. The thickness of the protective resin layer may be 20 μm to 60 μm, for example. The thickness of the laminate film may be 80 μm to 250 μm, for example.

### Collector Terminals

The solid-state battery 10 of the disclosure may also comprise collector terminals 140. The collector terminals may each be electrically connected to a current collector of the electrode stack. The materials of the collector terminals are not particularly restricted so long as they have a current collection function. As exemplified in FIG. 1, the positive electrode collector terminal and negative electrode collector terminal may be disposed on a pair of opposite side sections of the electrode stack. The positive electrode collector terminal and negative electrode collector terminal may be disposed apart from each other on one side section of the electrode stack.

The shapes and sizes of the collector terminals are not particularly restricted.

When the solid-state battery of the disclosure has collector terminals, the laminate film may house the electrode stack together with the collector terminals. Specifically, the laminate film may house the electrode stack together with the collector terminals by winding together the electrode stack and the collector terminals. The laminate film may also be constructed of first and second films, in which case the first and second films may sandwich the electrode stack and collector terminals from above and below in the stacking direction of the electrode stack, housing the electrode stack together with the collector terminals.

### Method for Producing Solid-State Battery

The first method of the disclosure for producing a solid-state battery 10 will now be explained.

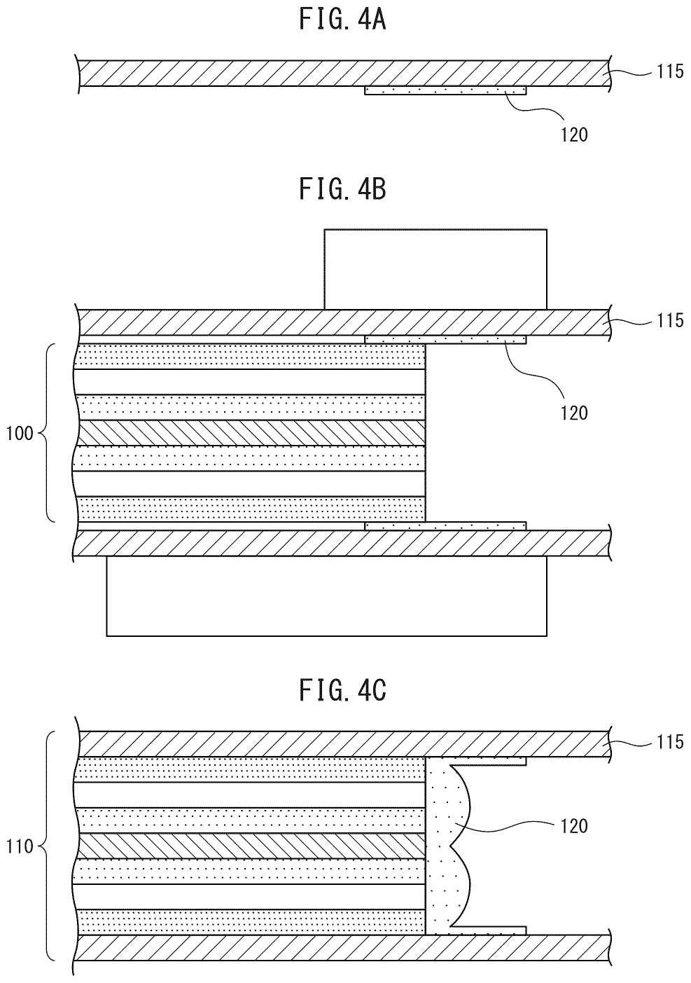

As exemplified in FIG. 4, the method of the disclosure for producing a solid-state battery 10 comprises the following steps: (a) stacking the first current collector layer 111, the first electrode active material layer 112, the solid electrolyte layer 113 and the second electrode active material layer 114 in that order to form a preliminary stack 100, (b) applying the insulating member 120 onto part of the second current collector layer 115, (c) stacking the second current collector layer 115 on the main side of the preliminary stack 100 in such a manner that the edge of the electrode stack 110 and the insulating member 120 match in the in-plane direction of the preliminary stack 100, (d) pressing the second current collector layer 115 to cause flow of the insulating member 120 at the edge of the preliminary stack 100, to form an electrode stack 110 with the insulating member 120 disposed on at least part of the edge, and (c) solidifying the insulating member 120.

In other words, the method of the disclosure allows the insulating member to be applied so as to connect the edge of the electrode stack and the second current collector layer. The method of the disclosure also comprises solidifying the insulating member. This allows firmer anchoring of the insulating member to the electrode stack, helping to prevent peeling of the insulating member from the electrode stack. The reliability of insulation by the insulating member is thereby improved.

The method of the disclosure also comprises pressing the second current collector layer to cause flow of the insulating member at the edge of the preliminary stack. The thickness of the solid-state battery produced by the method of the disclosure is therefore essentially uniform, and this results in improved volumetric efficiency for the battery.

The “preliminary stack”, for the purpose of the disclosure, is a stack having a first current collector layer, first electrode active material layer, solid electrolyte layer and second electrode active material layer in that order, allowing formation of an electrode stack by further stacking of a second current collector layer.

### Preliminary Stack-Forming Step

The method of the disclosure comprises (a) stacking the first current collector layer 111, first electrode active material layer 112, solid electrolyte layer 113 and second electrode active material layer 114 in that order to form a preliminary stack 100.

The method of stacking the layers is not particularly restricted, and for example, it may be a method of dry molding such as compaction, or wet molding using a slurry. For wet molding, first one side of the first current collector layer is coated with a first electrode mixture slurry that is able to form a first electrode active material layer, and then dried to obtain a first electrode active material layer layered on the first current collector layer. Using a solid electrolyte slurry then allows a solid electrolyte layer to be layered in the same manner on the first electrode active material layer. By using a second electrode mixture slurry it is possible to layer a second electrode active material layer in the same manner on the solid electrolyte layer.

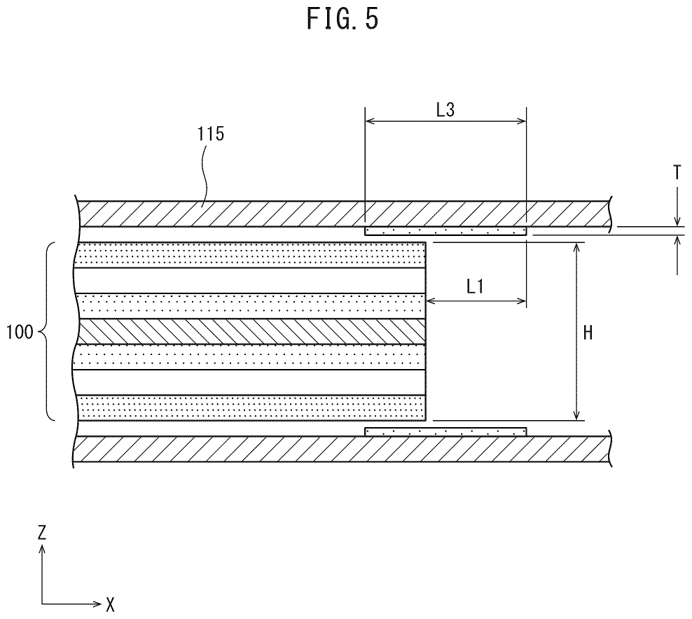

The height H of the preliminary stack, i.e. the length of the stacking direction, as illustrated in FIG. 5, is not particularly restricted, and for example, it may be 50 μm or greater, 100 μm or greater or 150 μm or greater, and 500 μm or less, 300 μm or less, 200 μm or less or 150 μm or less.

### Insulating Member Application Step

As exemplified in FIG. 4(a), the method of the disclosure comprises (b) applying the insulating member 120 to part of the second current collector layer 115.

The “part” in reference to step (b) may be specified by the length L3 in the x-direction of the insulating member (the in-plane direction of the electrode stack) (see FIG. 5). For example, the length L3 may be 100 μm or longer, 500 μm or longer, 1 mm or longer or 2 mm or longer, and 5 mm or shorter, 4 mm or shorter, 3 mm or shorter or 2 mm or shorter.

The amount of insulating member applied to the second current collector layer may be specified by the thickness of the insulating member (the length in the stacking direction of the electrode stack) T (see FIG. 5). For example, the thickness T may be 10 μm or greater, 50 μm or greater, 75 μm or greater or 100 μm or greater, and 300 μm or smaller, 200 μm or smaller, 150 μm or smaller or 100 μm or smaller.

The method for applying the insulating member is not particularly restricted, and it may be a method of coating the insulating member, for example.

### Second Current Collector Layer Stacking Step

As exemplified in FIG. 4(b), the method of the disclosure also comprises (c) stacking the second current collector layer 115 on the main side of the preliminary stack 100 so that the edge of the preliminary stack 100 and the insulating member 120 match in the in-plane direction of the preliminary stack 100.

The location for stacking the second current collector layer may be specified by the length L1 of the section of the insulating member extending from the edge of the electrode stack. As mentioned above, the length L1 may be 100 μm or longer, 300 μm or longer, 500 μm or longer or 1 mm or longer, and 3 mm or shorter, 2 mm or shorter, 1 mm or shorter or 500 μm or shorter, for example.

The thickness T, length L1 and height H satisfy the following relational expression: T (μm)×L1 (mm)×1000>10 (μm)×H (μm)/2.

If this relational expression is satisfied, then it will be possible to ensure the insulating property of the insulating member without substantially increasing the thickness of the battery at the section where the insulating member has been applied. Satisfying the relational expression will also make it easier for the insulating member to have a shape that is recessed toward the electrode stack (see FIGS. 2 and 4(c)).

### Electrode Stack Forming Step

As exemplified in FIGS. 4(b) and (c), the method of the disclosure also comprises (d) pressing the second current collector layer 115 to cause flow of the insulating member 120 at the edge of the preliminary stack 100, forming an electrode stack 110 with the insulating member 120 disposed on the edge.

The method for pressing the second current collector layer is not particularly restricted, and for example, it may be a method of pressing using a pressing member as exemplified in FIG. 4(b).

There are no particular restrictions on the direction of pressing. For example, the second current collector layer may be pressed in the stacking direction of the preliminary stack, and in particular, the second current collector layer may be pressed so that force is applied toward the edge of the preliminary stack. By pressing the second current collector layer so that force is applied toward the edge of the preliminary stack, it is possible to effectively cause flow of the insulating member at the edge of the preliminary stack.

### Insulating Member Solidification Step

The method of the disclosure also comprises (e) solidifying the insulating member 120.

In the method of the disclosure, the insulating member may include a thermoplastic resin, in which case the method may further comprise melting the thermoplastic resin in step (d), with the insulating member including the molten thermoplastic resin being caused to flow on the edge of the preliminary stack, while in step (e), the insulating member containing the molten thermoplastic resin may be solidified.

The thermoplastic resin will be understood by referring to the aforementioned description of the solid-state battery of the disclosure.

When the insulating member includes a thermoplastic resin, the second current collector layer may be heated to melt the thermoplastic resin, or the second current collector layer may be pressed to cause flow of the insulating member containing the molten thermoplastic resin at the edge of the preliminary stack. In particular, a heat bar may be used for combined heating and pressing of the second current collector layer.

The method for solidifying the insulating member containing the molten thermoplastic resin is not particularly restricted, and for example, it may be a method of cooling the insulating member. The method for cooling the insulating member is also not particularly restricted and may be a method of air-cooling, for example.

In the method of the disclosure, the insulating member may be a curable resin, in which case the insulating member that includes the curable resin may be solidified by curing in step (e).

The curable resin will be understood by referring to the aforementioned description of the solid-state battery of the disclosure.

The method for curing of the insulating member that includes the curable resin is not particularly restricted. When the curable resin is a photocuring resin, it may be cured by irradiating the curable resin with ultraviolet rays, for example. When the curable resin is a thermosetting resin, it may be cured by heating the curable resin.

The second method of the disclosure for producing a solid-state battery 10 will now be explained.

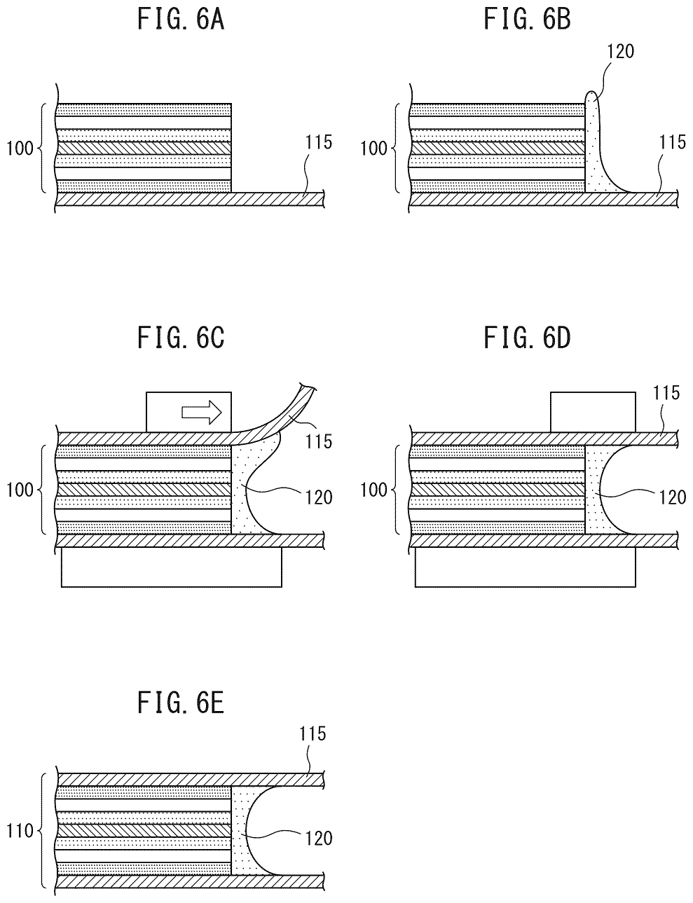

As exemplified in FIG. 6, the method of the disclosure for producing a solid-state battery comprises the following steps: (a) stacking the first electrode active material layer 112, the solid electrolyte layer 113 and the second electrode active material layer 114 in that order on both sides of the first current collector layer 111 to form a preliminary stack 100, (b) stacking the first second current collector layer 115 on one main side of the preliminary stack 100, (c) applying the insulating member 120 onto the edge of the preliminary stack 100 and at least part of the section of the first second current collector layer 115 extending from the preliminary stack 100, (d) stacking the second second current collector layer 115 onto the other main side of the preliminary stack 100, (e) pressing the second second current collector layer 115 to form an electrode stack 110 with the insulating member 120 disposed on the edge, and (f) solidifying the insulating member 120.

In other words, the method of the disclosure comprises solidification of the insulating member that has been applied so as to connect the edge of the electrode stack and the second current collector layer. This allows firmer anchoring of the insulating member to the electrode stack, helping to prevent peeling of the insulating member from the electrode stack. The reliability of insulation by the insulating member is thereby improved.

The method of the disclosure also comprises pressing the second current collector layer in a manner crushing the insulating member, to form an electrode stack with the insulating member disposed on the edge. The thickness of the solid-state battery produced by the method of the disclosure is therefore essentially uniform, and this results in improved volumetric efficiency for the battery.

### Preliminary Stack-Forming Step

The method of the disclosure comprises (a) stacking the first electrode active material layer 112, solid electrolyte layer 113 and second electrode active material layer 114 in that order on both sides of the first current collector layer 111 to form a preliminary stack 100.

The method of stacking each layer may be understood by referring to the aforementioned first method of the disclosure for producing a solid-state battery 10.

### First Second Current Collector Layer Stacking Step

As exemplified in FIG. 6(a), the method of the disclosure comprises (b) stacking the first second current collector layer 115 on one main side of the preliminary stack 100.

The method of stacking the first second current collector layer onto one main side of the preliminary stack is not particularly restricted. When the second current collector layer is a metal foil, for example, the method may be one in which the metal foil is disposed on the second electrode active material layer of the preliminary stack.

### Insulating Member Application Step

As exemplified in FIG. 6(b), the method of the disclosure also comprises (c) applying the insulating member 120 onto the edge of the preliminary stack 100 and at least part of the section that is extended from the preliminary stack, on the side of the first second current collector layer 115 which is in contact with the preliminary stack 100.

The method for applying the insulating member is not particularly restricted, and it may be a method of coating the insulating member, for example.

The insulating member applied at a desired location can spread out onto the first second current collector layer by surface tension.

### Second Second Current Collector Layer Stacking Step

As exemplified in FIG. 6(c), the method of the disclosure comprises (d) stacking the second second current collector layer on the other main side of the preliminary stack 100. The method of stacking the second second current collector layer is not particularly restricted, and it may be the same as the method for stacking the first second current collector layer.

### Electrode Stack Forming Step

As exemplified in FIGS. 6(c) and (d), the method of the disclosure also comprises (e) pressing the second second current collector layer 115 to form an electrode stack 110 with the insulating member 120 disposed on the edge.

The method for pressing the second current collector layer is not particularly restricted, and for example, it may be a method of pressing using a pressing member as exemplified in FIGS. 6(c) and (d).

There are no particular restrictions on the direction of pressing. For example, the second current collector layer may be pressed in the stacking direction of the preliminary stack, and in particular, the second current collector layer may be pressed so that force is applied toward the edge of the preliminary stack, as exemplified in FIG. 6(c). By pressing the second current collector layer so that force is applied toward the edge of the preliminary stack, it is possible to help prevent the insulating member from intruding between the preliminary stack and the second current collector layer. As a result it is possible to effectively inhibit increase in thickness of the solid-state battery at the section where the insulating member is disposed.

As exemplified in FIG. 6(d), the insulating member can spread out on the second current collector layer by surface tension, allowing the insulating member to adopt a shape that is recessed toward the electrode stack (see FIGS. 3 and 6(e)).

### Insulating Member Solidification Step

The method of the disclosure also comprises (f) solidifying the insulating member 120.

In the method of the disclosure, the insulating member may include a thermoplastic resin, in which case the method may further comprise melting the insulating member that includes the thermoplastic resin in step (c) and solidifying the insulating member that includes the molten thermoplastic resin in step (f).

The thermoplastic resin will be understood by referring to the aforementioned description of the solid-state battery of the disclosure.

When the insulating member includes a thermoplastic resin, the insulating member that includes the molten thermoplastic resin may be applied beforehand in step (c), or the insulating member including the thermoplastic resin may then be disposed at the desired location and then melted, for example. The molten state of the thermoplastic resin may also be maintained in steps (d) and (e).

The method for solidifying the insulating member containing the molten thermoplastic resin is not particularly restricted, and for example, it may be a method of cooling the insulating member. The method for cooling the insulating member is also not particularly restricted and may be a method of air-cooling, for example.

In the method of the disclosure, the insulating member may include a curable resin, or the insulating member that includes the curable resin may be solidified by curing in step (f).

The curable resin will be understood by referring to the aforementioned description of the solid-state battery of the disclosure.

The method for curing the insulating member that includes the curable resin is not particularly restricted. When the curable resin is a photocuring resin, it may be cured by irradiating the curable resin with ultraviolet rays, for example. When the curable resin is a thermosetting resin, it may be cured by heating the curable resin.

### Battery Module

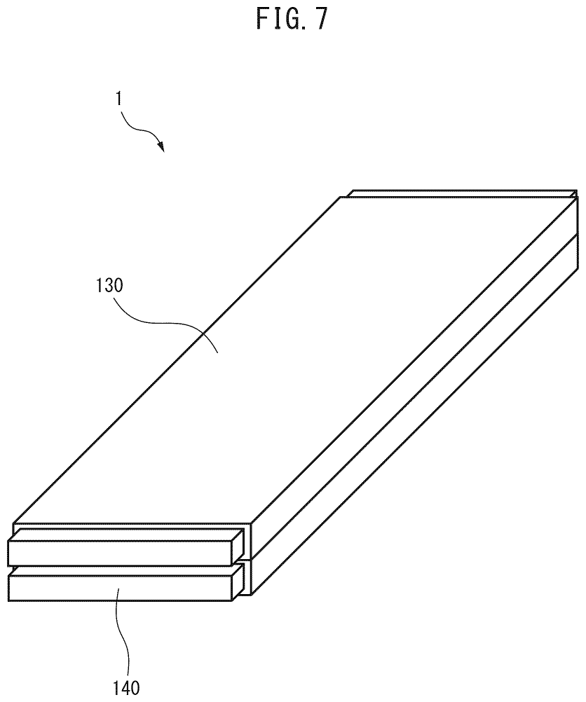

As exemplified in FIG. 7, the battery module 1 of the disclosure comprises a solid-state battery 10 of the disclosure. The solid-state battery of the disclosure will be understood by referring to the aforementioned description of the solid-state battery of the disclosure.

Since the thickness of the solid-state battery of the disclosure is essentially uniform, the effect of improved battery volumetric efficiency is even more pronounced in a battery module of the disclosure comprising multiple solid-state batteries of the disclosure.

The number of solid-state batteries of the disclosure in the battery module of the disclosure is not particularly restricted, but it is at least one. All of the batteries in the battery module of the disclosure may be solid-state batteries of the disclosure. FIG. 7 shows a case where the number of solid-state batteries is two, but the number of solid-state batteries in the battery module of the disclosure is not limited to two.

### REFERENCE SIGNS LIST

1 Battery module
10 Solid-state battery
100 Preliminary stack
110 Electrode stack
111 First current collector layer
112 First electrode active material layer
113 Solid electrolyte layer
114 Second electrode active material layer
115 Second current collector layer
120 Insulating member
130 Laminate film
140 Collector terminal

1. A solid-state battery comprising an electrode stack, wherein:
the electrode stack has a first current collector layer, a first electrode active material layer, a solid electrolyte layer, a second electrode active material layer and a second current collector layer, in that order,
an insulating member is disposed on at least part of the edge of the electrode stack, the second current collector layer extends from the edge of the electrode stack on which the insulating member is disposed,
the insulating member is joined with the electrode stack and the second current collector layer, and
the insulating member extends from the edge of the electrode stack along the second current collector layer.

2. The solid-state battery according to claim 1, wherein:
the electrode stack has the first electrode active material layer, the solid electrolyte layer, the second electrode active material layer and the second current collector layer in that order on both sides of the first current collector layer, and
the insulating member is joined with the electrode stack and the two second current collector layers.

3. The solid-state battery according to claim 2, wherein the insulating member has a shape that is recessed toward the electrode stack.

4. The solid-state battery according to claim 1, wherein the first current collector layer is a negative electrode collector layer, the first electrode active material layer is a negative electrode active material layer, the second electrode active material layer is a positive electrode active material layer and the second current collector layer is a positive electrode collector layer.

5. A battery module comprising a solid-state battery according to claim 4.

6. A method for producing a solid-state battery according to claim 1, the method comprising the following steps:
(a) stacking the first current collector layer, the first electrode active material layer, the solid electrolyte layer and the second electrode active material layer in that order to form a preliminary stack,
(b) applying the insulating member onto part of the second current collector layer,
(c) stacking the second current collector layer on the main side of the preliminary stack in such a manner that the edge of the preliminary stack and the insulating member match in the in-plane direction of the preliminary stack,
(d) pressing the second current collector layer to cause flow of the insulating member at the edge of the preliminary stack, to form an electrode stack with the insulating member disposed on at least part of the edge, and
(e) solidifying the insulating member.

7. The method according to claim 6, wherein:
the insulating member includes a thermoplastic resin, in step (d), the method further comprises melting the thermoplastic resin and the insulating member including the molten thermoplastic resin is caused to flow on the edge of the preliminary stack, and
in step (e), the insulating member containing the molten thermoplastic resin is solidified.

8. The method according to claim 6, wherein:
the insulating member is a curable resin, and
in step (e), the insulating member containing the curable resin is solidified by curing.

9. A method for producing a solid-state battery according to claim 3, the method comprising the following steps:
(a) stacking the first electrode active material layer, the solid electrolyte layer and the second electrode active material layer in that order on both sides of the first current collector layer to form a preliminary stack,
(b) stacking the first second current collector layer on one main side of the preliminary stack,
(c) applying the insulating member onto the edge of the preliminary stack and at least part of the section of the first second current collector layer that extends from the preliminary stack,
(d) stacking the second second current collector layer on the other main side of the preliminary stack,
(e) pressing the second second current collector layer to form the electrode stack having the insulating member disposed at the edge, and
(f) solidifying the insulating member.

10. The method according to claim 9, wherein:
the insulating member includes a thermoplastic resin,
in step (c), the method further comprises melting the insulating member including the thermoplastic resin and
in step (f), the insulating member containing the molten thermoplastic resin is solidified.

11. The method according to claim 9, wherein:
the insulating member includes a curable resin, and
in step (f), the insulating member containing the curable resin is solidified by curing.
